(19) United States
(12) Patent Application Publication
(10) Pub. No.: US 2005/0127052 A1
(43) Pub. Date: Jun. 16, 2005

(54) Near real time arc welding monitor

(76) Inventor: Mark Scott Spencer, Newington, CT (US)

Correspondence Address: Mark Scott Spencer, Appartment 12B, 83 Main Street, Newington, CT, 06111, US

(21) Appl. No.: 10/735,788

(22) Filed: Dec. 12, 2003

(51) Int. Cl. B23K 9/095

(52) U.S. Cl. 219/130.01

(57) ABSTRACT

An arc welding monitor designed to aid in the instruction of electric arc welding, provide data that can be used for inspection and quality assurance of individual welds, and provide an archive record of the arc welding process for future reference and analysis. A sensor is used to unobtrusively measure the welding arc parameters. The measurements are transmitted in real-time from the welding station to an instructor/supervisor workstation via a radio frequency data link. The received data is graphically displayed in near-real-time on the instructor/supervisor workstation computer screen. The data can be analyzed by standard statistical analysis tools to qualitatively grade the weld, be stored on computer disk storage media for later retrieval and analysis, or printed in a graphic display. Interpretation of the graphical display and statistical analysis is used to critique and instruct welder operator technique or to indicate process flaws that warrant further inspection of suspected welds.

### CROSS REFERENCE TO RELATED APPLICATIONS

Not Applicable

### FEDERALLY SPONSORED RESEARCH OR DEVELOPMENT

Not Applicable

### FIELD OF INVENTION

The invention relates generally to a monitor designed to aid in the instruction of electric arc welding and weld qualitative analysis. The invention pertains to arc welding operations manually controlled by a welder using both AC and/or DC welding equipment. The voltage, current, and other parameters of the arc during the welding process are monitored and the data is transmitted from the welding station to a personal computer located at a remote instructor/supervisor workstation via a radio frequency data link system. The data is graphically displayed in near-real-time on the personal computer screen at the instructor/supervisor workstation. Once the data is uploaded into the personal computer, the data is analyzed with standard statistical analysis techniques to provide a qualitative grade of the weld. The analyzed data is used for instruction of welding technique and quality assurance of individual welds. The data is stored on computer disk storage media for later retrieval and analysis or as an archive of the arc welding process.

### BACKGROUND OF THE INVENTION

Arc welding is widely used in the fabrication and repair of metal structures. In general, the source of heat for melting the weld material is an electric welding arc which is commonly referred to as an arc current flowing in the form of a plasma or gaseous conductor. The welding arc flows between the welding electrode and the work piece. The distance between the electrode and the work piece constitutes the arc length, and it may vary as the electrode is consumed. The arc welder operator controls the quality of the weld by intentionally manipulating the current and the voltage of the arc by varying the arc length to produce the desired weld. The arc welder operator technique in controlling the arc is the focus of welding instruction and is fundamental in determining the quality of the weld produced.

The arc voltage and current across a welding arc represents very closely the arc length conditions when other conditions of the arc, such as the characteristics of the weld rod used, the type of metal constituting the work piece, or the type of current used (AC or DC and polarity) are kept constant. A welder operator usually attempts to hold an arc of constant length, the value of the arc length suitable to the conditions of welding, including the composition of the work piece and the strength and quality of the weld desired.

The skilled arc welder operator controls the arc length by adjusting the proximity of the electrode to the work piece so as to produce a satisfactory weld. A skillful arc welder operator learns to recognize the sights and sounds associate with a good weld and make adjustments to the arc length as appropriate. However, a student learning arc welding frequently finds it difficult to maintain the proper arc length due to the judgment factors associated with interpreting the various sensory indicators (sights and sounds of welding). This constitutes the “art” of welding. Safety considerations and the close proximity that must be maintained between the welder operator and the welding arc prohibit active interaction between the welding instructor and the student during the welding process. Various attempts have been made to provide systems for monitoring the arc weld length and to provide a form of feedback to the arc welder operator that they can used to respond to changing arc conditions. U.S. Pat. No. 6,242,711 to Cooper shows a system that provides visual cues to the welder via a heads-up display of light emitting diodes viewed inside the welding helmet related to the voltage measured across the welding arc. U.S. Pat. No. 4,677,277 to Cook, U.S. Pat. No. 4,471,207 to Hawkes, U.S. Pat. No. 4,375,026 to Kierney, and U.S. Pat. No. 3,679,865 to Jesnitzer et al describe systems that provide acoustical feedback to the welder as indicators of arc length and quality. These efforts produce feedback that is usable only during the welding process; there is no record of the weld that can be used for further analysis after the welding event. The visual cues provided in one system add a distraction during the welding process and an instructor cannot monitor the cues. The acoustical feedback systems provide indicators that are hard to hear and interpret in a high noise environment that frequently surrounds a welding situation and again provide no record after the weld for additional analysis and instruction.

### BRIEF SUMMARY OF THE INVENTION

The overall object of the present invention is to address the short comings of previous attempts by providing a welding monitor which is capable of monitoring essential welding parameters without interfering with the welding current or voltage and transmit the information gathered on the welding parameters to an instructor's or supervisor's workstation at some safe distance from the welding station so that the welding parameters, and therefore the welding process, can be monitored in real-time and a record of the arc welder operator's performance can stored in computer files for later retrieval, review, and detailed statistical analysis.

A further object of the present invention is to provide the arc welding student with a visual, graphic depiction of the weld arc length, speed, and quality so that the instructor and student can study the student's welding technique and make corrections. A further objective of the present invention is to allow the instructor to analyze the data gathered by the welding monitor using standard statistical analysis tools to statistically grade the weld quality. Keeping a record of these statistical grades in a portfolio of welds accomplished by the arc welding student would allow the instructor to infer performance trends, identify arc welding student performance shortfalls, and develop and provide remedial instruction as necessary. A further object of the present invention is to provide the arc welding student with a portfolio of weld performance that can be used as an archival record of welding skill and ability.

A still further object of the present invention is to provide a means to unobtrusively inspect the quality of individual welds as the welds are being produced on the job site. The near-real-time inspection capability of the present invention can provide indicators that additional; more intrusive, detailed, and costly inspections of welds are warranted. An archival record of individual welds accumulated by the use of the present invention can serve as forensic evidence in quality assurance investigations.

In accordance with the above and other objects, the present invention comprises a welding monitor that is comprised of two components; a sensor and transmitter component, and a receiving and display component. The sensor and transmitter component is connected to a welder power supply capable of producing the desired current and voltage (AC and/or DC) for achieving a welding arc. In the practice of manual arc welding processes utilizing the apparatus of the invention, a welding torch or electrode holder for welding rods or welding wire is connected to a welding power supply and manipulated by the operator to produce welds. Using sensors at the point of the weld to determine voltage and/or current across the arc, the welding monitor sensor and transmitter component takes real-time measurements of the arc parameters during the welding process. The voltage and/or current values that are sensed by the present invention are converted into digital data by a microprocessor, with imbedded software. The data is then transmitted in real-time and asynchronously by multi-channel capable radio frequency transmitter.

The second component of the welding monitor is the receiving and display component. This component of the present invention includes a multi-channel radio frequency receiver and microprocessor interface, with imbedded software, that is connected to a standard personal computer, running spreadsheet software, at the instructor's or supervisor's workstation. The receiving and display component of the present invention receives the digital data being transmitted by the sensor and transmitter component. The microprocessor in the receiving and display component of the present invention converts the data and sends the data to the personal computer console via a data port connection. The personal computer software then displays the data in graphical form as it is being generated at the welding station. The instructor or supervisor then manipulates and stores the data as dictated by the classroom or job requirements for later retrieval and analysis.

Through proper radio channel selection, the instructor or supervisor can monitor multiple, discrete welding stations from a single personal computer console.

The principal feature of the present invention resides in the conversion of measured voltage and/or currents or other arc welding parameters at the welding station into digital data that is transmitted to an instructor's or supervisor's workstation at a safe distance from the welding station. A further principal feature of the present invention resides in the real-time collection, display, and storage of the voltage and/or current measurements for instructional, supervisory, quality assurance inspection, and or data archive purposes.

As the present invention permits the welding arc characteristics to be instantly viewed by the instructor or supervisor, and in near-real-time by the arc welding student or arc welder operator, a higher quality weld than previously attainable can be produced with excellent repeatability and control. The utilization of the present invention enhances the learning experience of the arc welding student, reduces inspection costs, and permits superior welds to be more economically produced than previously.

It is appreciated that various modifications to the inventive concepts may be apparent to those skilled in the art without departing from the spirit and scope of the invention.

### BRIEF DESCRIPTIONS OF THE DRAWINGS

FIG. 1 is a pictorial drawing of typical physical enclosures for the present invention.

FIG. 2 is a block diagram of an apparatus embodying the present invention.

FIG. 3 is a graphical display and tabular statistical analysis summary of data collected by an apparatus embodying the present invention.

FIG. 4 is an electrical schematic diagram of the welding monitor sensor and transmitter component embodiment of the present invention showing the interconnection of the apparatus to the welding equipment.

FIG. 5 is an electrical schematic diagram of the welding monitor receiver and display component embodiment of the present invention.

### DETAILED DESCRIPTION OF THE INVENTION

The following description of the preferred embodiments is presented to illustrate the present invention and is not to be construed to limit the scope of the appended claims in any way.

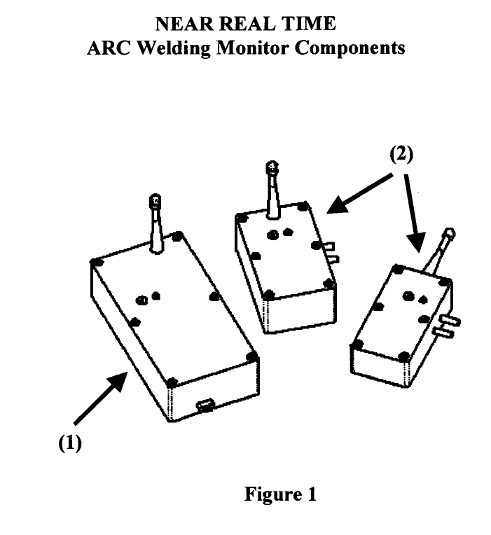

Typical physical protective enclosures of the present invention receiver and display component (1) and the sensor and transmitter component (2) are represented in FIG. 1.

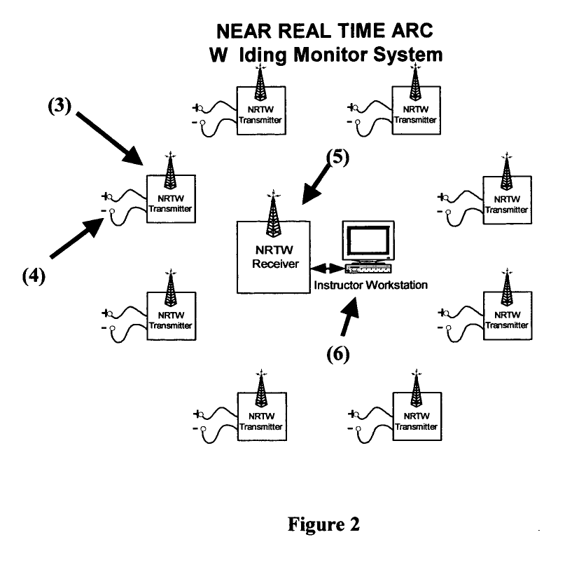

The overall depiction of the present invention is illustrated in the block diagram of FIG. 2. Individual welding monitor sensor and transmitter components are attached to the arc welding equipment located at arc welding workstation locations (3). The welding monitor is connected to the electrical output leads of the arc welding equipment (4) and the arc welder operator turns on the welding monitor to transmit on a pre-determined radio frequency channel. The arc weld operator then begins to weld.

The receiving and display component (5) of the present invention is located within reception range of the welding monitor sensor and transmitter components and is connected to a personal computer at the instructor or supervisor workstation (6). The instructor or supervisor turns on the receiver and display component of the welding monitor and selects the radio frequency channel of the welding station that is to be monitored from software running on the personal computer. The welding monitor receiver and display component then begins to receive and display the data representing the welding arc parameters being transmitted at the welding workstation. After the instructor or supervisor views each weld, the data is saved in a unique computer data file for later retrieval and analysis. The instructor or supervisor then can select a different radio frequency channel associated with a different, desired arc welder workstation and begin to monitor another weld as it is being produced.

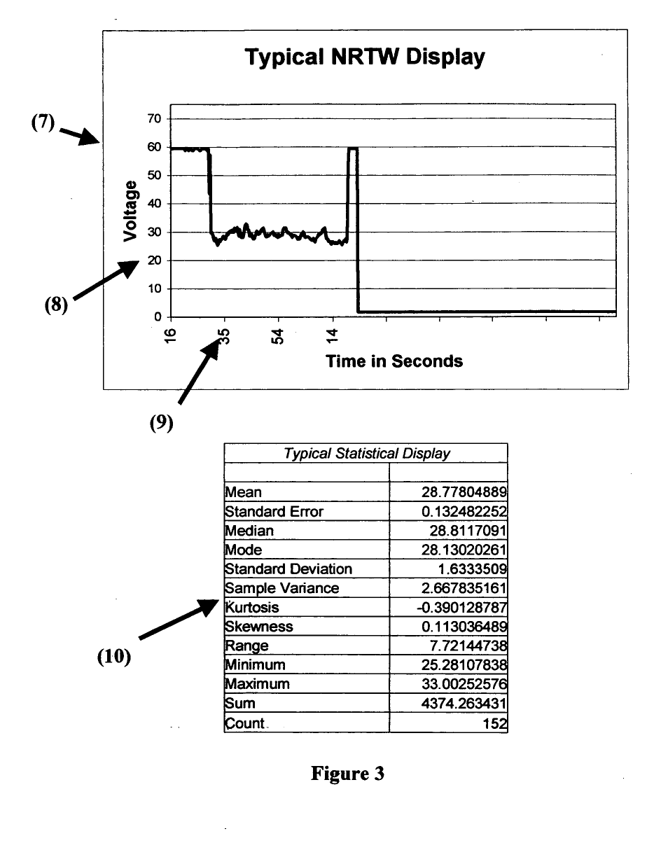

A typical display on the instructor's or supervisor's workstation console is depicted in FIG. 3. FIG. 3 shows the graphical display (7) of the weld arc voltage and/or current as a function of time. The Y-axis equates (8) to the weld arc length with high values representing increased length. The X-axis (9) equates to the time of the voltage and/or current measurement. The tabular data (10) represents a summary of statistical analysis information gathered from the data represented in the graphic.

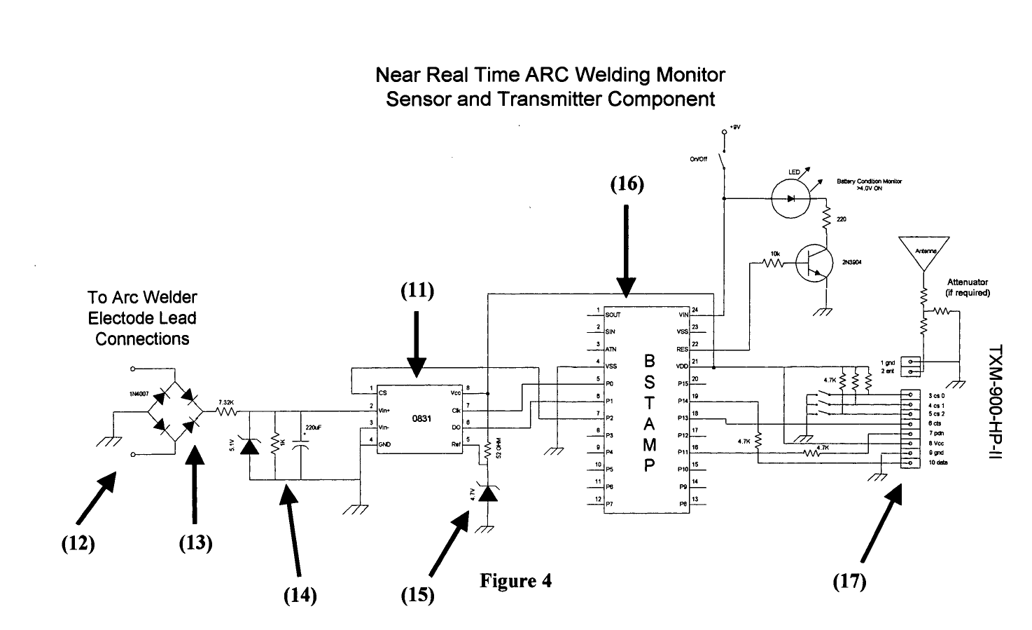

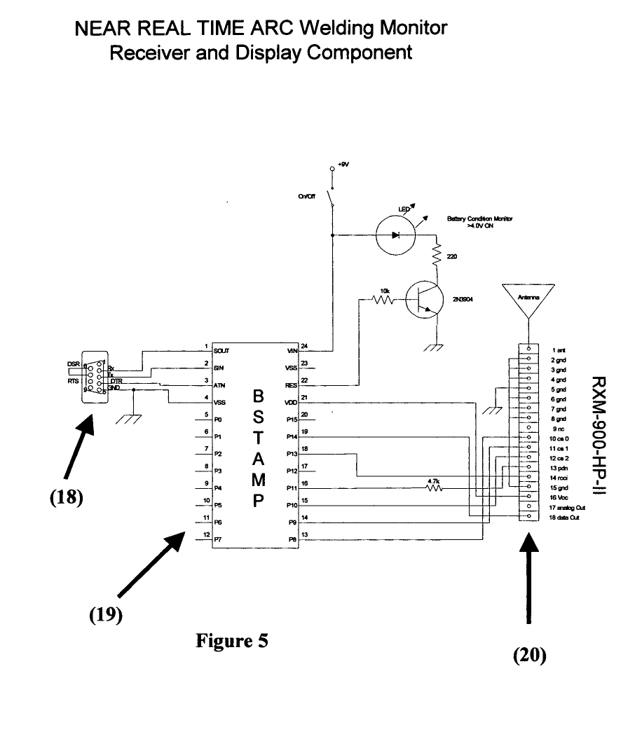

The diagrams in FIG. 4 and FIG. 5 represent the circuits of the present invention. The sensor and transmitter component in FIG. 4 will be described first. An analog to digital converter (11) is connected to the output of the welding equipment (12) through a bridge rectifier circuit (13). The bridge rectifier converts alternating current voltages into direct current voltages. This bridge rectifier circuit also eliminates the need for taking precautions for proper voltage polarity when connected to DC arc welding equipment. The bridge rectifier will pass direct current voltages to the analog to digital converter regardless of the polarity of the connections to the welding equipment. The output of the bridge rectifier is filtered using a resistor/capacitor filter (14). Over voltage protection is ensured by the actions of the protective zener diode. The output of the filter is applied to the analog to digital converter integrated circuit through a voltage divider circuit that provides a stepped down voltage that is proportional to the arc voltage and/or current. A regulated reference voltage is provided to the analog to digital converter integrated circuit by a zener diode (15). The output of the analog to digital converter integrated circuit is connected to the microprocessor (16). Embedded software within the microprocessor converts the analog to digital converter data into a format that is compatible with transmission over the radio frequency link to the receiving and display component. The microprocessor also controls the radio frequency channel of the transmitter and the transmitter operation. The software operation includes receiving the raw voltage and/or current measurement data from the analog to digital converter, completes data analysis and smoothing through a mathematical algorithm, converts the data into a format for transmission, turns on the radio frequency transmitter (17), and finally transmits the data.

The receiving and display component of the present invention in FIG. 5 is described in the following. The instructor or supervisor launches the controlling software of the present invention on a personal computer that is connected to the receiving and display component (18). The instructor or supervisor selects the radio frequency channel to be monitored that corresponds to the desired workstation. The personal computer software sends the channel information to the microprocessor (19) in the receiving and display component which in turn channels the receiver (20) to that channel. The microprocessor of the receiving and display component begins to monitor the selected radio channel for transmitted data. When data is being received, the microprocessor validates the data before software embedded in the microprocessor converts the received data into a format that is compatible with the protocol for data transmission to the personal computer serial port. The microprocessor then sends the data over the personal computer data port. The personal computer software in turn receives the voltage and/or current measurement data and displays the data graphically on the personal computer console monitor.

While the invention has been described in connection with what is presently considered to be the most practical and preferred embodiments, it is to be understood that the invention is not to be limited to the disclosed embodiments, but is intended to cover various modifications and equivalent arrangements, included within the spirit and scope of the appended claims.

1. A microprocessor controlled system for monitoring and aiding in user control of the welding arc produced by arc welding equipment during the arc welding process. The arc welding monitor system consists of two components:
1. Sensor and transmitter component comprising of a:
(a) Means to unobtrusively measure, in real-time, voltage and/or current of the welding arc produced by arc welding equipment located at a welding station.
(b) Means to convert the voltage and/or current analog measurements into digital form.
(c) Means to prepare the digital form of voltage and/or current measurements for transmission over a radio frequency data link.
(d) Means to control a radio frequency data link transmitter.
(e) Means to transmit voltage and/or current measurements via a radio frequency data link transmitter on user selected frequency channels in near-real-time

2. Receiving and display component comprising of a:
(a) Means to receive the measurements of voltage and/or current at an instructor or supervisor workstation that is a safe distance and within the reception range of the welding monitor sensor and transmitter component and on a user selected radio frequency channel.
(b) Means to validate the received data and detect and discard corrupted data.
(c) Means to convert the received arc voltage and/or current measurement data into a format that can be sent to a personal computer via a data port.
(d) Means to send the arc voltage and/or current measurement data to a personal computer via a data port.
(e) Means of displaying the received arc voltage and/or current measurements in near-real-time on a workstation personal computer console monitor.
(f) Means of storing the received arc voltage and/or current measurement data on computer disk storage media.

3. The apparatus of claim 1 wherein:
(a) Said arc welding equipment in first named means supplies alternating and/or direct current at its output;
(b) Said second named means is a welder output voltage and/or current sensor connected to the arc welding equipment at a location conducive to arc voltage and/or current;
(c) Said second named means is a sensor that converts voltage and/or current measurements into digital form;
(d) Said third named means is a microprocessor that converts the digital information from the sensor into a format that can be transmitted by the radio frequency transmitter;
(e) Said fourth named means is a microprocessor that controls the radio frequency transmitter channel selection and operation;
(f) Said fifth named means is a microprocessor that sends the voltage and/or current measurements to the radio frequency transmitter for transmission;
(g) Said fifth named means is a radio frequency transmitter that transmits the voltage and/or current data to the receiving and display component of claim 2.

4. The apparatus of claim 2 wherein:
(a) Said first named means is by a microprocessor controlled radio receiver that receives the data transmitted by the apparatus in claim 1 on a user selected radio frequency channel;
(b) Said second named means is by algorithm analysis of received data accomplished by software embedded in a microprocessor;
(c) Said third named means is by a microprocessor and embedded software that converts the received voltage and/or current measurement data into a format that is suitable for transmission to a personal computer via a serial data port;
(d) Said fourth named means is by a microprocessor that sends the received voltage and/or current measurement data via a data port in the appropriate format to a personal computer;
(e) Said fifth named means is by computer software programs that allow the user of the apparatus to graphically display the voltage and/or current measurement data.
(f) Said sixth named means is by computer software programs that allow the user to analyze and store voltage and/or current measurement data.
